(19) United States
(12) Patent Application Publication
(10) Pub. No.: US 2011/0191110 A1
(43) Pub. Date: Aug. 4, 2011

(54) Multi-parameter physical audio signal decoding system

(75) Inventors: Shih-Jung Chang, Taipei (TW); Chao-Fa Lee, Taipei (TW); Cheng-Hsing Kuo, Taipei (TW)

(73) Assignee: Tatung Company, Taipei (TW)

(21) Appl. No.: 12/659,591

(22) Filed: Mar. 15, 2010

(30) Foreign Application Priority Data
Jan. 29, 2010 (TW) 099102574

(51) Int. Cl. G10L 21/00

(52) U.S. Cl. 704/500; 704/E21.001

(57) ABSTRACT

A multi-parameter physical audio signal decoding system includes an audio capturing device, a signal pre-processor, a signal decoder, a data modulator and a display device. The audio capturing device receives audio signals, and transforms them into digital signals in real time. The digital signals are transmitted to the signal pre-processor. The signal decoder decodes the digital signals. The data modulator removes signal noises. The display device displays the modulated digital signals. In a non-real-time decoding process, an audio file recorded with physical signals is transmitted to the pre-processor to proceed the decoding process.

### BACKGROUND OF THE INVENTION

1. Field of the Invention

The invention relates generally to a signal decoding system and, more particularly, to a multi-parameter physical audio signal decoding system.

2. Description of Related Art

An audio signal encoding device is capable of transforming multi-channel signals into an audio file, and thus can be applied to various fields. For instance, the audio signal encoding device can receive physical signals generated from human bodies, so as to provide a simple medical interpretation.

Generally, the physical monitoring parameters of human beings belong to low frequency signals. In the daily life, a user may use the audio signal encoding device to catch physical signals generated from human bodies, such as respiratory signal waveform, electrocardiogram waveform, pulse, gastrointestinal electro-gram waveform, brain waveform and body temperature. Accompanied with an audio signal decoding device, these recorded physical signal waveforms can be read for simple medical interpretation.

The main function of the audio signal decoding device is to restore the transformed multi-channel signals. Owing to analog physical signals being transformed into digital physical signals, it is likely to have signal distortion. Therefore, how to decode audio signals efficiently and display readable waveforms would be the main subject of the audio signal decoding device.

### SUMMARY OF THE INVENTION

An object of the present invention is to provide a multi-parameter physical audio signal decoding system, so as to give physical information captured by an audio capturing device to doctors or nurses for simple medical interpretation.

To achieve this object, there is provided a multi-parameter physical audio signal decoding system, which comprises: an audio capturing device for receiving audio signals, transforming the audio signals into digital signals and storing the digital signals temporarily; a signal pre-processor electrically connected to the audio capturing device for pre-processing the digital signals; a signal decoder electrically connected to the signal pre-processor for decoding the pre-processed digital signals; a data modulator electrically connected to the signal decoder for modulating the decoded signal signals; and a display device electrically connected to the data modulator for displaying the modulated digital signals.

Another object of the present invention is to provide a multi-parameter physical audio signal decoding system, so as to give a decoded audio file recorded with physical information to doctors or nurses for simple medical interpretation.

To achieve this object, there is provided a multi-parameter physical audio signal decoding system, which comprises: a signal pre-processor for receiving a digital audio file representing physical signals and pre-processing digital signals of the digital audio file; a signal decoder electrically connected to the signal pre-processor for decoding the pre-processed digital signals; a data modulator electrically connected to the signal decoder for modulating the decoded signal signals; and a display device electrically connected to the data modulator for displaying the modulated digital signals.

### BRIEF DESCRIPTION OF THE DRAWINGS

FIG. 1 shows a system diagram in accordance with a first preferred embodiment of the present invention;

FIG. 2 shows an operating flowchart in accordance with the first preferred embodiment of the present invention;

FIG. 3 shows a physical signal waveform in accordance with the first preferred embodiment of the present invention;

FIG. 4(a) shows an electrocardiogram in accordance with the first preferred embodiment of the present invention;

FIG. 4(b) shows a respiratory signal diagram in accordance with the first preferred embodiment of the present invention;

FIG. 5 shows a system diagram in accordance with a second preferred embodiment of the present invention; and

FIG. 6 shows an operating flowchart in accordance with the second preferred embodiment of the present invention.

### DETAILED DESCRIPTION OF THE PREFERRED EMBODIMENT

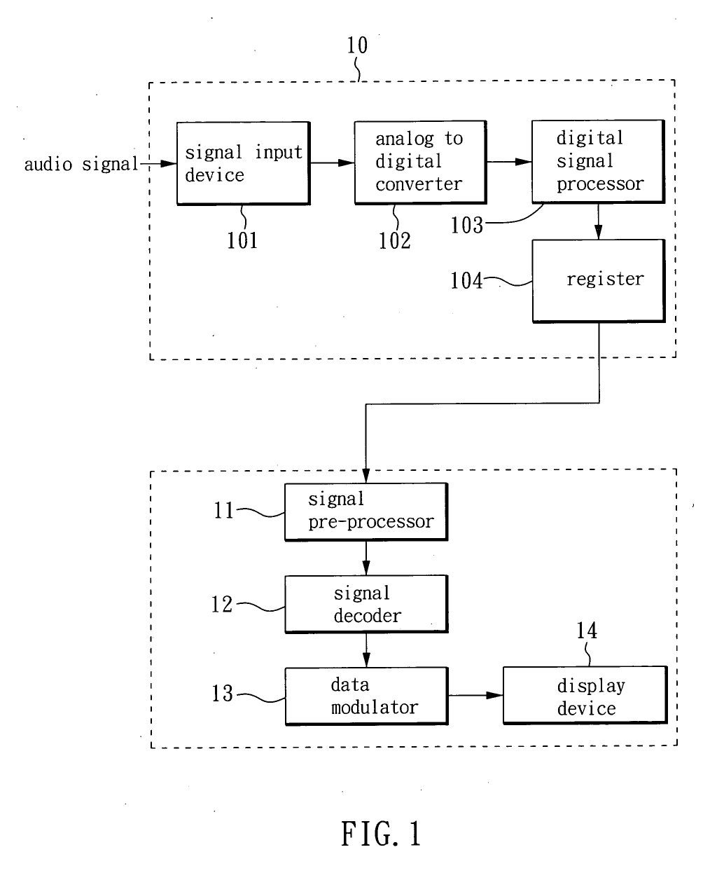

With reference to FIG. 1, there is shown a multi-parameter physical audio signal decoding system in accordance with a preferred embodiment of the present invention. As shown, the multi-parameter physical audio signal decoding system includes an audio capturing device 10, a signal pre-processor 11, a signal decoder 12, a data modulator 13 and a display device 14. The audio capturing device 10 includes a signal input device 101, an analog to digital converter 102, a digital signal processor 103 and a register 104. The register 104 of the audio capturing device 10 is electrically connected to the signal pre-processor 11. The signal pre-processor 11 is electrically connected to the signal decoder 12. The signal decoder 12 is electrically connected to the data modulator 13. The data modulator 13 is electrically connected to the display device 14.

The audio capturing device 10 receives audio signals via the signal input device 101. The received audio signals are transformed into digital signals by the digital converter 102 and the digital signal processor 103, and then are stored in the register 104 as a digital audio file. The audio signals have a set of reference voltages (V+,V−) for use as starting signals of the digital audio file.

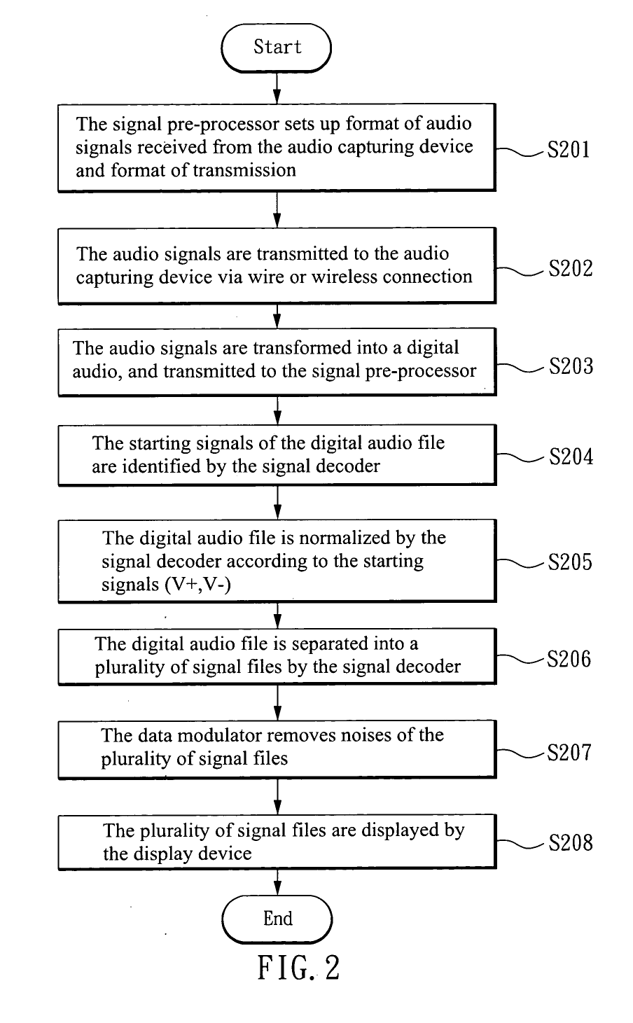

With reference to FIG. 2, there is shown an operating flowchart of the multi-parameter physical audio signal decoding system illustrated in FIG. 1. In step S201, the signal pre-processor 11 sets up the format of audio signals received from the audio capturing device 10 and the format of transmission. In the step S202, the audio signals are transmitted to the audio capturing device 11 via wired or wireless connection. Owing to that there are many types in the audio signals, the embodiment illustrates an example for clear illustration.

If a user places a physical signal capturing device in front of his/her breast, signals received by the physical signal capturing device include electrocardiogram and respiratory signals. These signals are transformed into an audio file by the physical signal capturing device 10. Therefore, the audio signals stored in the audio capturing device 10 as the audio file include electrocardiogram and respiratory signals.

In step S203, the audio file is transformed into a digital audio file by the audio capturing device 10, and transmitted to the signal pre-processor 11 to analyze the digital audio file instantly. In step S204, the starting signals of the digital audio file are identified by the signal decoder 12. In step 205, the digital audio file is normalized by the signal decoder 12 according to the starting signals, so as to arrange amplitudes of the audio signals of the digital audio file between V+ and V−.

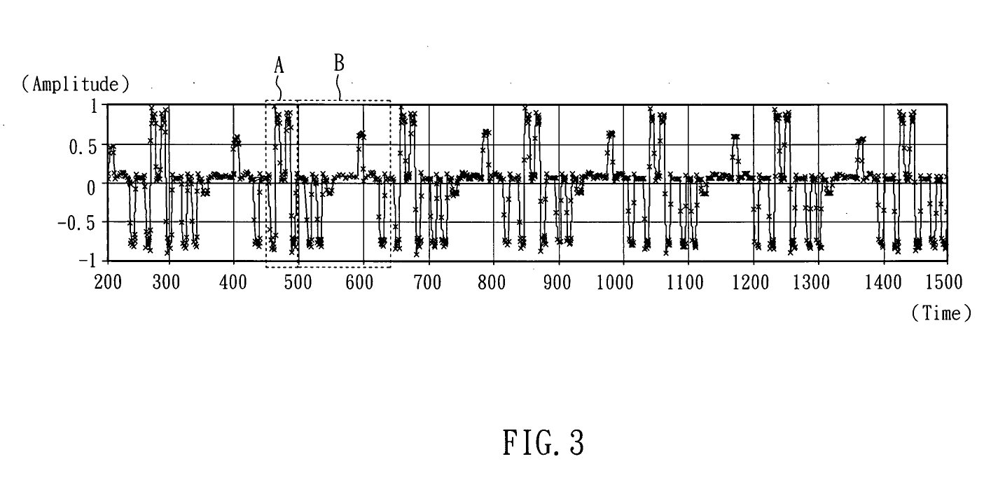

FIG. 3 shows a waveform diagram of the normalized digital audio file. As shown, section A stands for a periodic wave of the starting signals, and section B stands for a periodic wave of the digital audio file. In step 206, the digital audio file is separated into a plurality of signal files by the signal decoder 12. In this embodiment, the digital audio file is separated into electrocardiogram and respiratory signals.

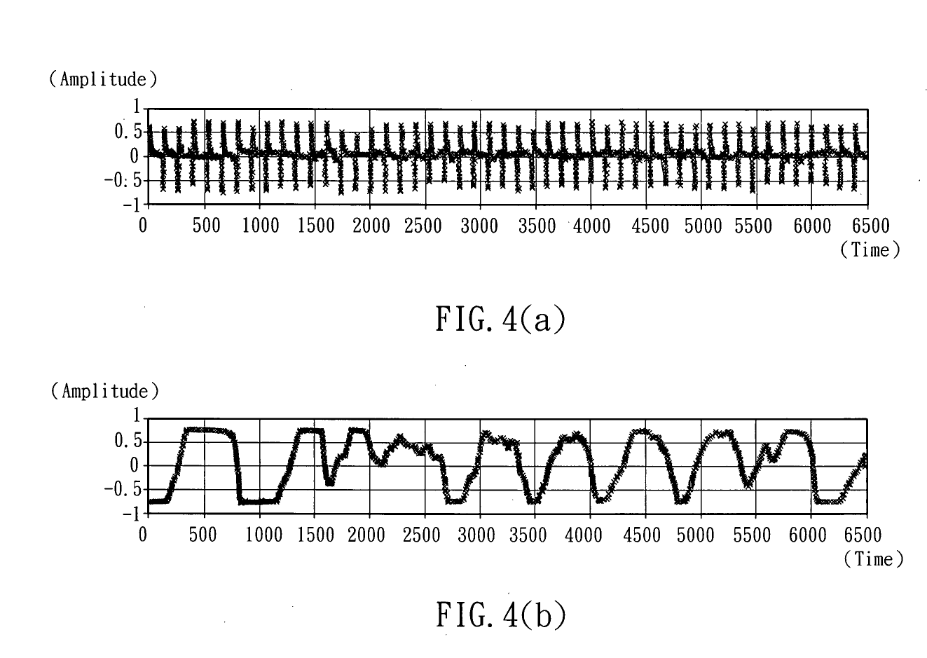

In step 207, the data modulator 13 removes noises of the plurality of signal files. Finally, in step 208, the plurality of signal files are displayed by the display device. The electrocardiogram is shown as FIG. 4(a), and the respiratory signals are shown as FIG. 4(b).

In addition to transmitting digital audio file and analyzing its waveform in real time, the present invention also provides a system for transmitting digital audio file and analyzing its waveform in a non-real-time manner.

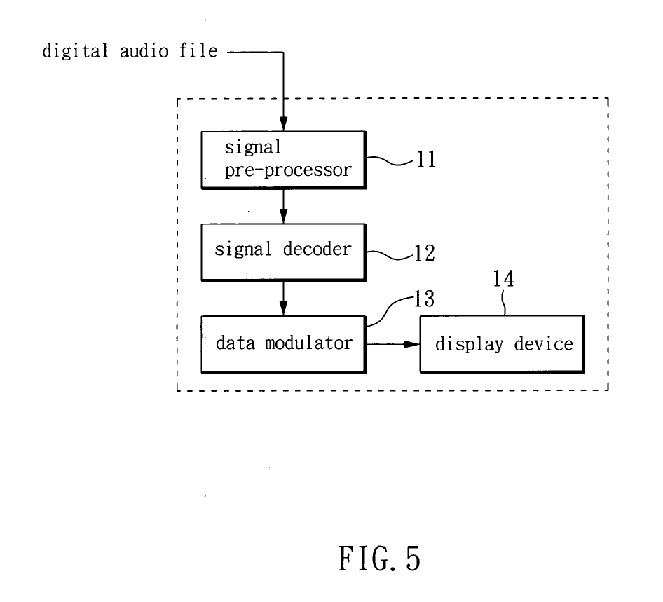

With reference to FIG. 5, there is shown a multi-parameter physical audio signal decoding system in accordance with another preferred embodiment of the present invention, which includes a signal pre-processor 11, a signal decoder 12, a data modulator 13 and a display device 14. The signal pre-processor 11 is electrically connected to the signal decoder 12. The signal decoder 12 is electrically connected to the data modulator 13. The data modulator 13 is electrically connected to the display device 14.

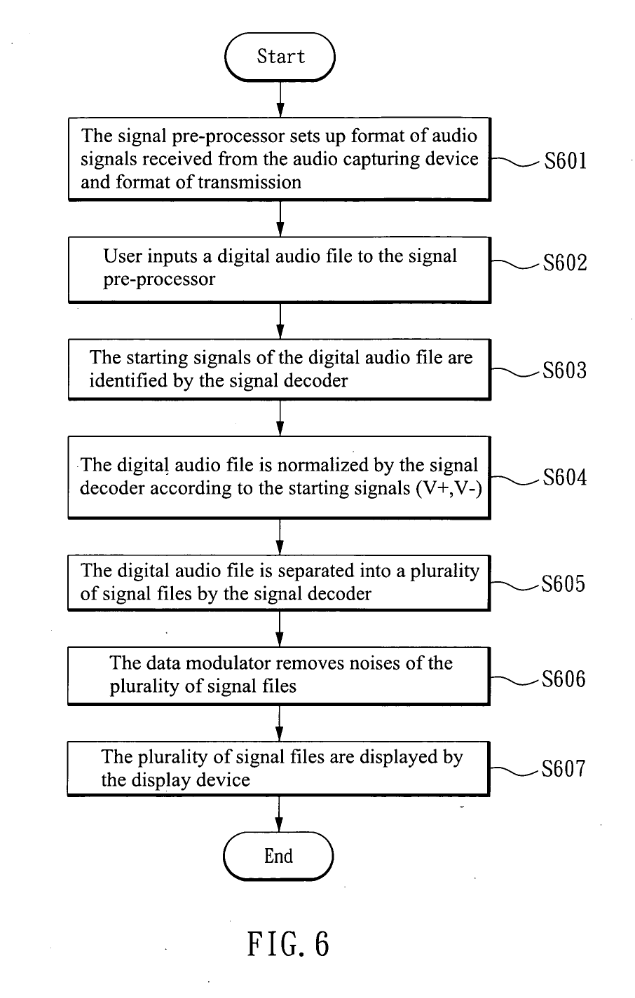

With reference to FIG. 6, there is shown the operating flowchart of the multi-parameter physical audio signal decoding system illustrated in FIG. 5. In step S601, the signal pre-processor 11 sets up the format of received audio signals and the format of transmission. In step S602, a user inputs a digital audio file into the audio capturing device 11. The digital audio file with the present embodiment contains a plurality of physical signals including electrocardiogram and respiratory signals. Besides, the digital audio file contains a set of reference voltages (V+,V−) for use as starting signals.

In step S603, the starting signals of the digital audio file are identified by the signal decoder 12. In step 604, the digital audio file is normalized by the signal decoder 12 according to the starting signals, so as to arrange amplitudes of the physical signals of the digital audio file between V+ and V−.

In step 605, the digital audio file is separated into a plurality of signal files by the signal decoder 12. In this embodiment, the digital audio file is separated into electrocardiogram and respiratory signals. In step 606, the data modulator 13 removes noises of the plurality of signal files. In step 607, the plurality of signal files are displayed by the display device finally.

In view of the foregoing, it is known that the multi-parameter physical audio signal decoding system of the present invention is able to provide doctors or nurses with physical information for analyzing instantly, or provide doctors or nurses with decoded physical information file for analyzing, so as to improve the quality of medical care efficiently.

Although the present invention has been explained in relation to its preferred embodiment, it is to be understood that many other possible modifications and variations can be made without departing from the spirit and scope of the invention as hereinafter claimed.

What is claimed is:

1. A multi-parameter physical audio signal decoding system, comprising:
an audio capturing device for receiving audio signals, transforming the audio signals into digital signals and storing the digital signals temporarily;
a signal pre-processor electrically connected to the audio capturing device for pre-processing the digital signals;
a signal decoder electrically connected to the signal pre-processor for decoding the pre-processed digital signals;
a data modulator electrically connected to the signal decoder for modulating the decoded signal signals; and
a display device electrically connected to the data modulator for displaying the modulated digital signals.

2. The multi-parameter physical audio signal decoding system of claim 1, wherein the audio capturing device includes a signal input device, an analog to digital converter, a digital signal processor and a register.

3. The multi-parameter physical audio signal decoding system of claim 2, wherein the signal pre-processor sets up format of audio signals received from the audio capturing device and format of transmission.

4. The multi-parameter physical audio signal decoding system of claim 3, wherein the audio signals are transmitted to the audio capturing device via wire or wireless connection.

5. The multi-parameter physical audio signal decoding system of claim 4, wherein the audio signals have a set of reference voltages (V+, V−) for use as starting signals of the audio signals.

6. The multi-parameter physical audio signal decoding system of claim 5, wherein the audio signals are transformed into a digital audio file by the audio capturing device.

7. The multi-parameter physical audio signal decoding system of claim 6, wherein the starting signals of the digital audio file are identified by the signal decoder.

8. The multi-parameter physical audio signal decoding system of claim 7, wherein the digital audio file is normalized by the signal decoder according to the starting signals.

9. The multi-parameter physical audio signal decoding system of claim 8, wherein the digital audio file is separated into a plurality of signal files by the signal decoder.

10. The multi-parameter physical audio signal decoding system of claim 9, wherein the data modulator removes noises of the plurality of signal files.

11. The multi-parameter physical audio signal decoding system of claim 10, wherein the plurality of signal files are displayed by the display device.

12. A multi-parameter physical audio signal decoding system, comprising:
a signal pre-processor for receiving a digital audio file representing physical signals and pre-processing digital signals of the digital audio file;
a signal decoder electrically connected to the signal pre-processor for decoding the pre-processed digital signals;
a data modulator electrically connected to the signal decoder for modulating the decoded signal signals; and
a display device electrically connected to the data modulator for displaying the modulated digital signals.

13. The multi-parameter physical audio signal decoding system of claim 12, wherein the signal pre-processor sets up an audio signal format and a transmission format.

14. The multi-parameter physical audio signal decoding system of claim 13, wherein the digital audio file has a set of reference voltages (V+,V−) for use as starting signals.

15. The multi-parameter physical audio signal decoding system of claim 14, wherein the starting signals of the digital audio file are identified by the signal decoder.

16. The multi-parameter physical audio signal decoding system of claim 15, wherein the digital audio file is normalized by the signal decoder according to the starting signals.

17. The multi-parameter physical audio signal decoding system of claim 16, wherein the digital audio file is separated into a plurality of signal files by the signal decoder.

18. The multi-parameter physical audio signal decoding system of claim 17, wherein the data modulator removes noises of the plurality of signal files.

19. The multi-parameter physical audio signal decoding system of claim 18, wherein the plurality of signal files are displayed by the display device.
